(19) United States
(12) Patent Application Publication
(10) Pub. No.: US 2026/0100577 A1
(43) Pub. Date: Apr. 9, 2026

(54) HYBRID GENERATOR SYSTEM

(71) Applicant: Stored Energy Systems LLC, Longmont, CO (US)

(72) Inventor: William KAEWERT, Longmont, CO (US)

(21) Appl. No.: 19/350,743

(22) Filed: Oct. 6, 2025

Related U.S. Application Data
(60) Provisional application No. 63/703,419, filed on Oct. 4, 2024.

(51) Int. Cl. H02J 3/00; H02J 3/18; H02J 7/00

(52) U.S. Cl. CPC H02J 3/0012; H02J 3/18; H02J 7/875; H02J 2101/24

(57) ABSTRACT

Provided is a customer-sited hybrid generator system that coordinates a bidirectional inverter, an energy storage battery, an engine-driven generator, an optional renewable source, a controllable load bank, and an isolation switch under a supervisory controller, to supply facility loads and interact with a power grid. The controller enables multiple modes, including surge support during normal operation, under-frequency export from the battery with generator takeover, over-frequency import to charge the battery, and distributed curtailment using a resistive load thermally coupled to a liquid cooling loop. Electrically driven pumps and fans, a radiator, and a three-way valve route coolant among power electronics, engine, and curtailment loops. During a grid outage, the system may connect the generator directly to a facility bus, while isolating the inverter so the battery-backed inverter can provide parallel hybrid surge. The system interfaces with utility or VPP dispatch and supports either 50 Hz or 60 Hz interconnection.

This application claims the benefit of U.S. Patent Application Ser. No. 63/703,419, filed Oct. 4, 2025, which is incorporated by reference herein.

U.S. Pat. Nos. 9,948,125 and 12,062,935, which are attributed to the Applicant of this application, and which describe aspects of battery charging, are incorporated by reference herein in their entireties.

### FIELD OF THE INVENTION

Embodiments of the present invention generally relate to systems for supplying electrical energy, and more particularly to hybrid battery/generator systems configured to provide backup power.

### BACKGROUND OF THE INVENTION

The following background discussion is not an admission that the matters discussed below are citable as prior art or common general knowledge. Rather, the general background information disclosed herein is directed at describing the problem(s) associated with the current state of the art, and a need for a better solution.

The United States electric power grid is a large, interconnected system that delivers electricity from generating facilities to end users through regional transmission and distribution networks. It is generally divided into three major interconnections: the Eastern Interconnection, the Western Interconnection, and the Electric Reliability Council of Texas. Electricity is produced by centralized generating stations, transmitted over high-voltage lines, and distributed locally through substations to homes, businesses, and industrial facilities. Grid operators must maintain real-time balance between generation and demand to avoid instability and outages. There are growing challenges to both electrical power grid reliability and electric power prices in the United States and in many other parts of the world. In industrialized countries these challenges are being driven by fast-growing electric loads and simultaneously replacement of dispatchable fossil power generation by non-dispatchable renewables.

This phenomenon has led to the rise of several practices, including the management of power demand by virtual power plant operators (VPPs) and adoption of battery energy storage systems (BESS) located both on customer premises and power utility property. Power utilities also offer interruptible power contracts that reduce grid load by disconnecting customers that can self-power with on-site power generators. These systems, however, fail to address areas of critical energy demand, including the need for rapidly injecting power into the power grid to provide primary frequency response, need for longer duration battery run-times to support long periods where renewables' power output falls short of demand, the very high cost of long-duration battery run-time, and the opportunity to address the paradox of renewable energy systems, which is periodic over-generation of electric power.

Traditionally, the electric power grid was designed with minimal storage capacity. Electricity was generated and consumed almost simultaneously, with little buffering available. However, one established form of grid-scale storage has been hydroelectric facilities that use off-peak or excess electricity to pump water into an elevated reservoir and later release it through turbines to generate power during peak demand. Those of ordinary skill in the art will appreciate that other energy storage solutions currently exist, such as compressed air/gas storage, gravity-based storage, geothermal energy storage, thermal energy storage, etc. Also, smaller-scale lead-acid batteries have historically been used for emergency backup. These traditional storage approaches, however, are geographically limited, slow to deploy, or otherwise constrained, and thus cannot be readily scaled to meet modern grid challenges.

As shown in FIGS. 1 and 2, electric power demand in North America is projected to sharply increase, while power generation mix has shifted away from fully dispatchable thermal resources toward variable wind and solar resources. As baseload coal capacity retires, the effective contribution of intermittent resources during critical hours is often lower than required, which can erode reserve margins and increase the likelihood of service interruptions during peak conditions. Thus, the proliferation of variable renewable energy sources such as wind and solar has further increased the need for flexible storage and load management. Renewable generation often produces excess electricity during off-peak periods, followed by shortages at times of high demand. To address these imbalances, many utilities now impose time-of-use (TOU) pricing, in which customers pay higher rates for electricity consumed during peak demand hours. This structure incentivizes customers to shift usage away from costly peak periods, but it also imposes significant costs on businesses and facilities that cannot readily alter their demand patterns.

In many wholesale market regions, constrained capacity during scarcity events can drive prices to regulatory caps that are orders of magnitude above typical levels, materially increasing average energy costs when such events persist. Conversely, periods of high renewable output may produce negative pricing, creating additional volatility for industrial and commercial customers. These dynamics complicate planning for facilities that must maintain power quality and cost predictability.

Further exacerbating these issues is that large-scale transmission expansion has not kept pace with the changing generation portfolio. Regulatory approvals, right-of-way acquisition, financing challenges, supply chain limitations, and multi-jurisdiction coordination often delay new lines, limiting the ability of central infrastructure to mitigate near-term reliability and price volatility.

To manage these risks, customers have adopted local, “behind-the-meter” strategies such as energy storage for time-of-use shifting, demand-charge reduction, and fast frequency response. That is, energy storage systems provide an effective means of mitigating these issues. By charging batteries or other storage devices during low-cost, off-peak hours and discharging them during peak hours, customers can significantly reduce their exposure to high rates. This form of load shifting also supports the grid by smoothing demand spikes and reducing reliance on peaking generation assets. Energy-oriented batteries can discharge for several hours to avoid high TOU periods, while power-oriented batteries can deliver short-duration frequency services that support grid stability and may generate revenue. However, existing storage and management systems often lack the integration, efficiency, or adaptability needed to fully exploit these opportunities. And many existing deployments are single-purpose and do not fully coordinate with on-site generation, load management, or grid-services markets.

Despite these developments, there remains a need for improved power systems that reliably coordinate storage, generation, power conversion, and facility loads; adapt to rapidly changing grid conditions and prices; and interface with grid authorities to stack reliability and economic functions without compromising the facility's primary power requirements.

### SUMMARY OF THE INVENTION

It is one aspect of embodiments of the present invention to provide a customer-sited hybrid system that integrates storage, engine-driven generation, bidirectional inverters, and supervisory controls located behind an isolation switch, and that communicates with power-grid operators or virtual power-plant platforms. The contemplated system can operate in multiple modes, including normal grid-parallel operation, surge support to avoid costly utility-service upgrades, automated under- and over-frequency response, short-duration ride-through during outages using storage, and longer-duration operation using on-site generation. Where photovoltaics or load banks are present, these assets may be coordinated to export during periods of high prices, consume during periods of negative prices, or provide additional grid support.

It is another aspect of some embodiments of the present invention to provide a novel hybrid generator system for supplying critical energy demands and for curtailing excess power generation on the grid. This hybrid generator system may be deployed with a conventional power grid, including grids supplied at least in part by renewable energy sources, or in microgrids operating independently of the public power grid.

The hybrid generator system is analogous to a hybrid vehicle. In a hybrid vehicle, battery energy, via power electronics and related components, enables instant acceleration or dynamic braking and can power short-duration trips without starting the combustion engine. For longer trips, the hybrid vehicle's source of propulsion transitions from battery to combustion engine before the battery is fully depleted. Regenerative braking converts mechanical energy into electrical energy to recharge the battery.

Similarly, the hybrid generator system employs a combination of a storage battery, power electronics, a combustion engine, an auxiliary load, and a sophisticated control system to power on-site facility loads while also enabling the export of electrical power to the grid or the import of excess grid power, both instantaneously and for durations limited only by the available fuel for the engine. The hybrid generator system can also power facility loads during a grid outage and provide sufficient capacity to start large surge loads during such an outage.

In some embodiments, an inverter is configured to immediately provide surge power to support large building or other high demand electrical loads, also known as surge loads. The inverter and other components of the system alleviate problems associated with sourcing additional capacity from the power utility to support surge loads. The inverter is preferably configured to provide an instant, proportional response to decaying grid frequency.

For example, the system may comprise a “primary frequency response” function, which not only helps the wider grid during grid emergencies, but also supplies a valuable source of cashflow to generating asset owners. This is particularly beneficial as traditional dispatchable power sources feeding the grid are retired in favor of non-dispatchable wind, solar and other renewable generating assets. This “frequency response” application is preferably “stacked” atop the surge load support application, thus increasing return on investment on the hybrid genset solution. A fleet of such hybrid generators could be coordinated via data communications by a power utility, balancing authority or by a virtual power plant operator (VPP), of which there are several.

Some embodiments of the present invention consist generally of a hybrid generator (i.e., hybrid genset) configured to operate autonomously to provide continuous power to the facility it supports, despite public power grid outage, or to export power to the public power grid when sensing systems in the hybrid generator detect that grid frequency has decayed past a critical threshold (e.g., an under-frequency response). Alternatively, the system may immediately export power to the public power grid upon receipt of a command from the power utility, VPP or other authorized authority controlling the public power grid.

A person of ordinary skill in the art will appreciate that “frequency response” means that the equipment providing the response needs to both export power to the grid (to boost under frequency) and import power from the grid (to suppress over frequency). For instance, a nominal five-minute capacity battery maintained at 60% state of charge (SOC) would be expected to discharge until exhausted for three minutes into the system inverter exporting power to the grid or increase its state of charge to 100% over two minutes when importing power from the grid. A recurring problem in this situation arises when the need for energy export or import extends beyond two minutes. Both shortage and excess of generation are unpleasant facts that occur more frequently in power grids with growing concentration of renewable energy sources.

“Curtailment” means that PV and wind generation above grid load must be consumed at time of use or disposed of (wasted). As PV and wind generation increase, the demand for curtailment will also increase. According to recent articles, 44% of electricity in the European Union was generated by renewables in 2023. The same year, 21% of electricity was generated by renewables in the U.S. See https://www.wsj.com/business/energy-oil/electricity-that-costs-nothingor-even-less-its-happening-more-and-more-53f16e49 (last accessed on Oct. 1, 2024).

Embodiments of the present invention solves the curtailment issue and several other problems in the art relating to power grid demand variability. For example, but not limitation, prolonged curtailment (i.e., lasting longer than the battery can sink power) may be provided by a resistive load bank, such as the ones described herein. Excess energy from the grid beyond that sunk into the battery could be dissipated in the resistive load bank. In embodiments, the resistive load bank may be attached to, or associated with, the hybrid generator system. This configuration permits nearly unlimited curtailment to be realized and provide additional cash flow in areas where there is a market for curtailment. Referring again to the Wall Street Journal article, in certain geographic areas wholesale customers are being paid to consume electric power during periods of excess renewable generation. In other embodiments, one or more VPPs may use and benefit from this curtailment capture function.

It is another aspect of the present invention to provide a hybrid battery charging system configured for use with a plurality of batteries supplied to meet the demands of a particular electrical load, e.g., NiZn batteries, lead-acid batteries, lithium, and other battery types familiar to those of ordinary skill.

It is one aspect of some embodiments of the present invention to provide a hybrid generator system associated with an alternating-current power grid and a facility load; comprising: an inverter associated with the power grid and to a battery; a generator electrically associated with the inverter; a renewable power source electrically associated with the inverter; an isolation switch configured to disconnect a facility from the power grid during a power outage; an isolation load associated with the isolation switch and the power grid; a system controller in communication with the inverter, the generator, the battery, the isolation switch, the auxiliary load, and the renewable power source; wherein, during a grid under-frequency event, the system controller commands the inverter to export power to the grid from the battery; and wherein, during a grid over-frequency condition or a negative-price interval, the system controller commands the inverter to draw power from the grid to charge the battery, and when battery capacity to draw power is exceeded or a curtailment threshold is met, the system controller commands the inverter to connect the auxiliary load to consume surplus power.

It is another aspect of some embodiments of the present invention to provide a hybrid generator system for operation with facility loads when a power grid is unavailable; comprising; an inverter having a grid port and at least one non-grid port; a battery connected to the non-grid port; a generator connected by a first switch directly to an AC load bus; a second switch configured, when closed, to isolate the inverter from the generator while connecting the generator to the AC load bus; and wherein, during a grid outage, a controller synchronizes the generator to the inverter and closes the second switch to deliver generator power directly to a DC bus while the inverter draws from at least one of the battery and DC bus to augment start-up surge for a duration limited by the battery's capacity.

It is still yet another embodiment of the present invention to provide a method of operating a hybrid generator system; comprising; synchronizing an inverter with a power grid; maintaining a battery associated with the inverter at partial state of charge; detecting a grid under-frequency event; exporting power to the grid from the battery via the inverter; starting an engine-driven generator and continuing power export to the grid; and upon a grid outage, opening an isolation switch and supplying facility loads from the battery via the inverter until a generator assumes a longer-duration operation.

It is yet another aspect of some embodiments of the present invention to provide a method of distributed curtailment using a hybrid generator system; comprising; detecting an over-frequency condition or a negative-price interval on a power grid; commanding an inverter to import power from the power grid to charge a battery to a target state of charge; in response to continued excess generation; connecting an electrical load bank to the inverter to consume surplus power while maintaining facility loads; and controlling a liquid cooling circuit to dissipate heat from the electrical load bank.

It is still yet another aspect of embodiments of the present invention to provide a method of operating a hybrid generator system including an inverter connected to a facility alternating-current (AC) bus, a battery connected to a direct-current (DC) port of the inverter, a generator selectively connectable to the AC bus, an on-site renewable power source connected to the inverter, a controllable load bank, an isolation switch between the AC bus and a power grid, and a controller in communication with each component, the method comprising: in a first mode of use, during normal grid operation, maintaining the battery at a partial state of charge while the inverter operates in synchronism with the power grid to supply facility loads and to augment grid power during transient load surges without starting the generator; in a second mode of use, during a grid under-frequency event, exporting power from at least the battery through the inverter to the grid and, when the event persists beyond the battery's capacity, starting the generator and continuing export of power to the grid while supplying facility loads; in a third mode of use, during a grid outage, opening the isolation switch to isolate a facility and initially supplying facility loads from the battery through the inverter, then starting the generator to provide longer-duration support and optionally to recharge the battery; in a fourth mode of use, during a grid over-frequency condition or other excess-generation event, importing power from the grid to charge the battery through the inverter and, when battery capacity to absorb power is exceeded, connecting the controllable load bank to the inverter to consume surplus power; in a fifth mode of use, during a grid outage that requires surge power beyond generator capacity, synchronizing the inverter with the generator and connecting the generator directly to the facility AC bus while the inverter draws power from the battery in parallel with the generator for a duration limited by the battery's capacity; and controlling transitions among the modes according to sensed grid and facility conditions and commands received from a grid authority.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description.

Embodiments of the present invention is set forth in various levels of detail in the Summary of the Invention as well as in the attached drawings, and no limitation as to the scope of the present invention is intended by either the inclusion or non-inclusion of elements, components, etc. in this Summary of the Invention. Additional aspects of the present invention will become more readily apparent when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary and in the Figure(s) appended hereto.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a chart illustrating projected energy consumption.

FIG. 2 is a chart showing U.S. electricity generation by energy source.

FIG. 3 is a schematic showing an on-site power system of one embodiment of the present invention.

FIG. 4 is a schematic showing the on-site power system during normal operations.

FIG. 5 is a schematic showing the on-site power system during normal grid operations with facility overload support.

FIG. 6 is a schematic showing the on-site power system providing under frequency support to a power grid.

FIG. 7 is a schematic showing the on-site power system supporting the power grid.

FIG. 8 is a schematic showing a battery of the on-site power system providing instant support of facility loads when during grid failure.

FIG. 9 is a schematic showing a generator of the on-site power system providing is the support of facility loads when during grid failure.

FIG. 10 is a schematic showing a renewable power system contributing power to facility loads and the grid.

FIG. 11 is a schematic of one embodiment of an on-site power system configured to provide over frequency support.

FIG. 12 is a schematic of one embodiment of an on-site power system configured to provide distributed curtailment.

FIG. 13 is a schematic of one embodiment of an on-site power system configured to operate as a hybrid inverter/generator.

FIG. 14 a schematic view of a hybrid generator system of one embodiment of the present invention.

FIG. 15 shows the concept of peak shaving.

FIG. 16 is a schematic showing an on-site power system of one embodiment providing grid buffering.

FIG. 17 is a schematic showing an on-site power system of one embodiment providing back up power during grid failure.

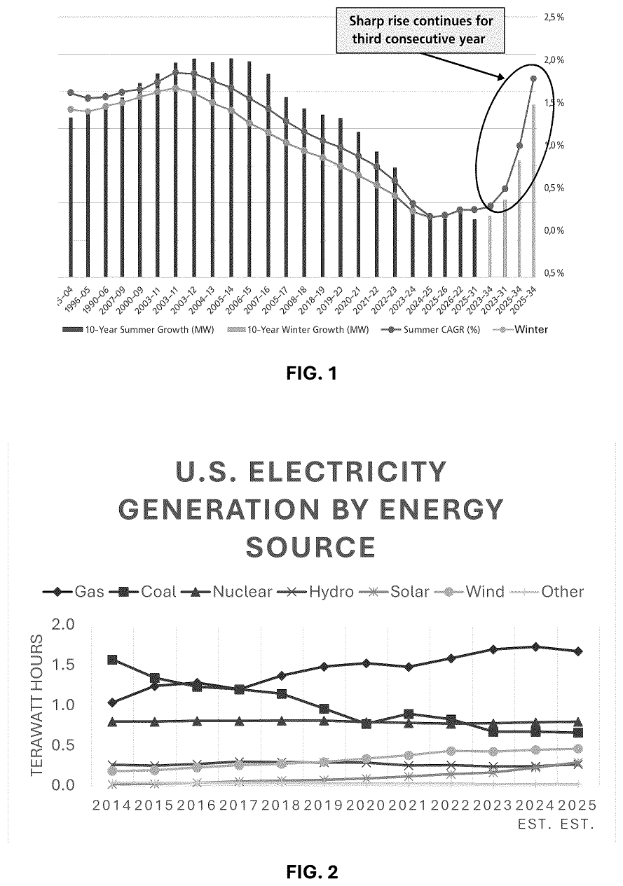

The following component list and associated numbering found in the drawings is provided to assist in the understanding of one embodiment of the present invention:

| Reference No. | Component |
|---|---|
| 1 | Hybrid Generator System |
| 2 | AC power grid |
| 6 | Utility meter |
| 10 | On-site power system |
| 14 | Facility loads |
| 18 | Bidirectional inverter |
| 22 | Battery |
| 26 | Generator |
| 30 | Renewable source |
| 34 | System controller |
| 38 | Load bank |
| 42 | Load bank switch |
| 50 | Grid Control Authority |
| 54 | Isolation switch |
| 60 | Generator-bus switch |
| 68 | Second bidirectional inverter |
| 100 | Hybrid Generator System |
| 118 | Inverter |
| 122 | Battery subsystem |
| 126 | Prime mover |
| 170 | Liquid cooling system |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

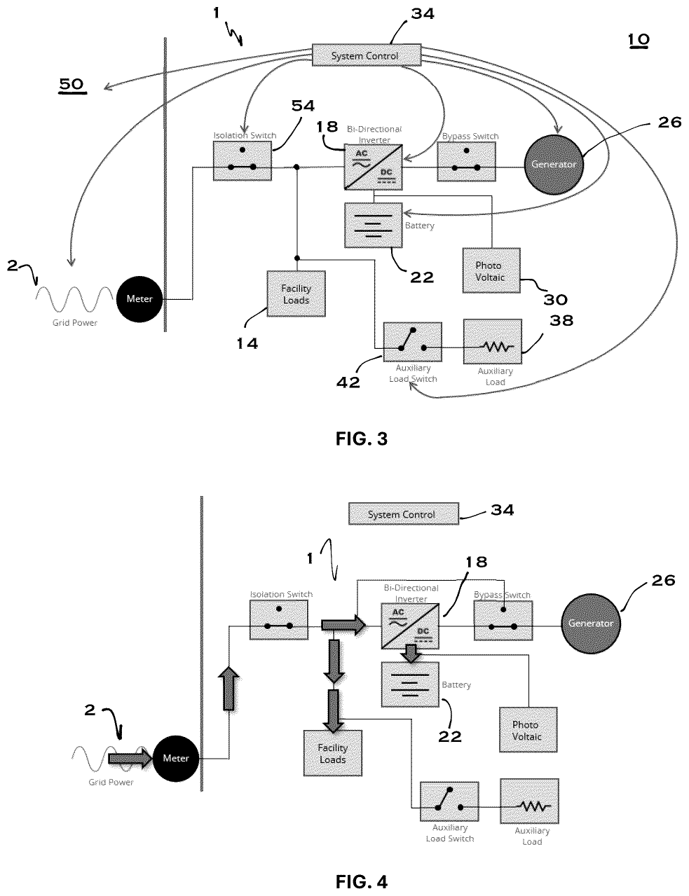

Referring now to FIGS. 3-13, additional aspects of the present invention are shown. Note that FIG. 3 includes a system diagram with depicted communication interfaces. FIGS. 4-13 depict different operating modes of the system, including flows of electric power, wherein the communication interface lines are removed only for the purposes of improving clarity. All FIGS. 3-13 assume that at least one controller associated with the system is in communication with all elements of the grid and on-site power system.

FIG. 3 shows an on-site power system 1 of one embodiment of the present invention. As one of ordinary skill in the art an alternating current (AC) power grid 2, single or three phase, 50 or 60 Hz of any available voltage (e.g. 480 VAC, 3-ph, 120 VAC, 1-ph, etc.) is interconnected by way of an electric meter 6 to and on-site power system 10 of a facility, wherein the electric meter 6 is the electrical and billing interface between the grid power provider (e.g., Xcel Electric) and the facility, such as a business or dwelling. Herein, the on-site power system is also referred to as a “Hybrid Generator System.” The Hybrid Generator System 1 is located in an industrial facility, residence, hospital, military base, or other electrical consuming facility. Each of these facilities have “loads” 14, i.e., electrical requirements that may be critical—lights, motors, etc., which are “behind the meter,” meaning downstream of the electric power meter 6 that marks the interface between power utility and its customer. The Hybrid Generator System 1 could also reside on the grid side of the meter for use by the power utility. Facility loads 14 comprise all or a portion of electrical loads in the facility, which are the same loads that could be powered in facilities equipped with a conventional onsite generating (“genset”) system.

The system 1 of one embodiment of the present invention employs an inverter 18, which may be a bi-directional power converter, and connected to the power grid 2, the facility loads 14, a battery 22, a generator 26, and a power generating source 30. The renewable on-site power generating source 30 can be one or more photovoltaic panels, wind turbines, etc. Although the inverter 18 is shown with only one non-grid direct current (DC) connected port, the inverter 18 could have more than one non-grid port, or one or more non-grid AC ports. In operation, the inverter 18 is energized and synchronized with the power grid 2. The inverter 18 is configured to comply with relevant technical standards (i.e., IEEE 1547, UL 1741, etc.) that enable exporting of power from the Hybrid Generator System 1 to the power grid 2. The inverter 18 could be implemented as a monolithic unit or comprising multiple modules working together. The inverter also could be of either non-isolated or galvanically isolated design.

The system battery 22 is connected to a DC port of inverter 18 such that it can be either recharged or discharged. When operated at partial state of charge (PSOC), the battery would be capable of instantaneously delivering current to, or accepting current, from inverter 18.

The on-site power generator 26 employs a prime mover such as a gaseous or diesel-fueled reciprocating engine, gas turbine, or hydro-electric turbine capable of dispatch in response to either manual or automated command a system controller 34.

An on-site load bank 38 may be configured to dissipate electrical energy capable of consuming AC from the grid 2. The load bank 38 is also configured to consume AC from the inverter 18 and/or the generator 26 as a test load for the battery 22, the inverter 18, and/or the engine. Although the schematic shows an electric resistance element, any load that consumes electrical power is intended. The electric resistance load is connected to the grid/inverter AC bus via switch 42. The switch 42 response either manually or automatically as commanded from the system controller 34 to either isolate the load bank number 38 from, or connected to load bank 38, to the inverter 18. The switch 42 either connects or disconnects the load bank 38 the power supplied by the inverter 18.

In one embodiment the load bank 38 is at least one electrical heating element either embedded in, or in thermal connection with, the engine's liquid cooling system, wherein the engine's radiator and could be reused to dissipate excess energy into the liquid cooling system at lower cost than a dedicated load bank heat dissipation system.

The system controller 34 is in communication with all elements on the grid and on-site power sides of the system. The controller 34 responds to changing conditions in the grid 2, changing conditions in the on-site power system 1, and to commands from a grid control authority. The grid control authority 50 may be any entity, e.g., power utility company, Independent System Operator (ISO), Virtual Power Plant (VPP), etc., with the authority and means to remotely control the dispatch of distributed energy resources (DER) to either generate electric power or curtail excess generation.

In isolation switch 54 is provided and designed to isolate the on-site power system 1 from the grid 2. The normal position of this switch 54 is closed, wherein the inverter 18 is connected to the grid 2 to, thus, connect the on-site power system 1 to the grid 2. During blackout, however, the on-site power system 1 must immediately disconnect from the grid 2 for practical, safety, and standards compliance reasons.

FIG. 4 illustrates operation of the Hybrid Generator System 1 during normal grid operations, wherein the power grid 2 supplies normal power to the facility. The battery 22 is maintained at an appropriate state of charge by the inverter 18.

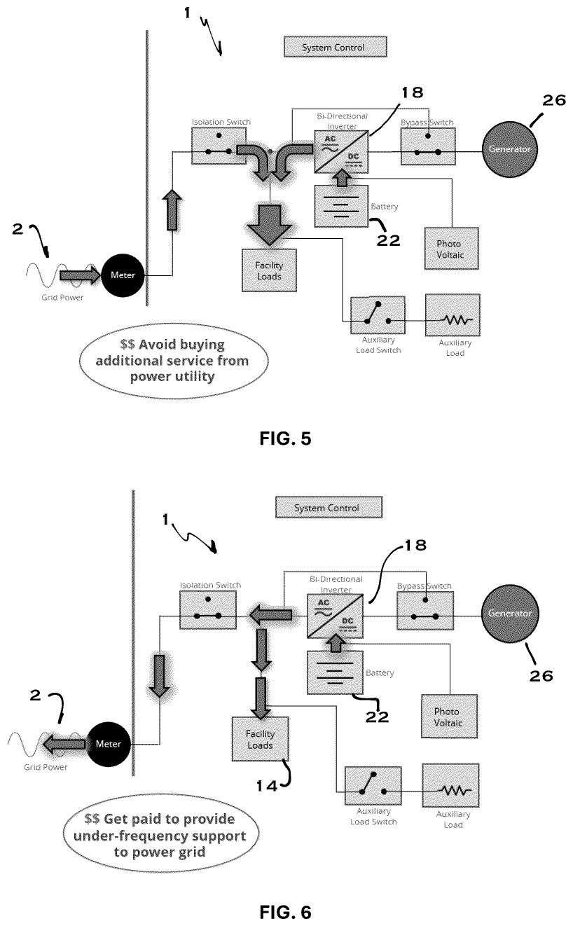

FIG. 5 depicts the Hybrid Generator System 1 function during normal grid operations, with facility overload support. Here, normal grid conditions are in effect, but there is a large surge in facility load caused, for example, by starting a large motor. One of ordinary skill in the art will appreciate that large load surges have the potential to trip facility input breakers (not shown), or cause facility brownouts that can damage processes or equipment. During such load surges, the battery 22 and inverter 18 are able to provide near instant response while the generator 26 remains in an unpowered standby mode saving fuel and preventing wear. FIG. 4 further depicts the inverter 18 augmenting grid power to support an excessive facility load. Not depicted is the generator 26 providing longer-duration support of facility loads, as might be required should the utility supplying grid power be unable or unwilling to provide higher capacity service to the facility.

FIG. 6 depicts the Hybrid Generator System providing under-frequency support to the grid 2. High concentrations of renewable energy generation is often accompanied by under- and over-frequency excursions because wind and solar generation do not provide system inertia (i.e., “spinning reserve”) inherent to the heavy spinning generators used in coal or nuclear powerplants. Here, the inverter 18 responds nearly instantly to a grid under-frequency event by converting battery DC into AC that is fed to the power grid 2 and facility loads 14. The inverter may be capable of independently detecting and reacting to the under-frequency event, or the inverter 18 may be dispatched in response to a command from the system controller 34. The system controller 34, in turn, may be the means of detection of the under-frequency event, or may react to signals from the grid control authority.

The inverter 18 is capable of providing either real or reactive power, as determined by the system controller 34 or the grid control authority. When under-frequency events last longer than the battery's capacity, the generator 26 would start before the battery is fully discharged. A building management system (not shown) may simultaneously reduce low-priority facility loads, such as air conditioning, to maximize the proportion of power exported from the on-site power system to the grid 2.

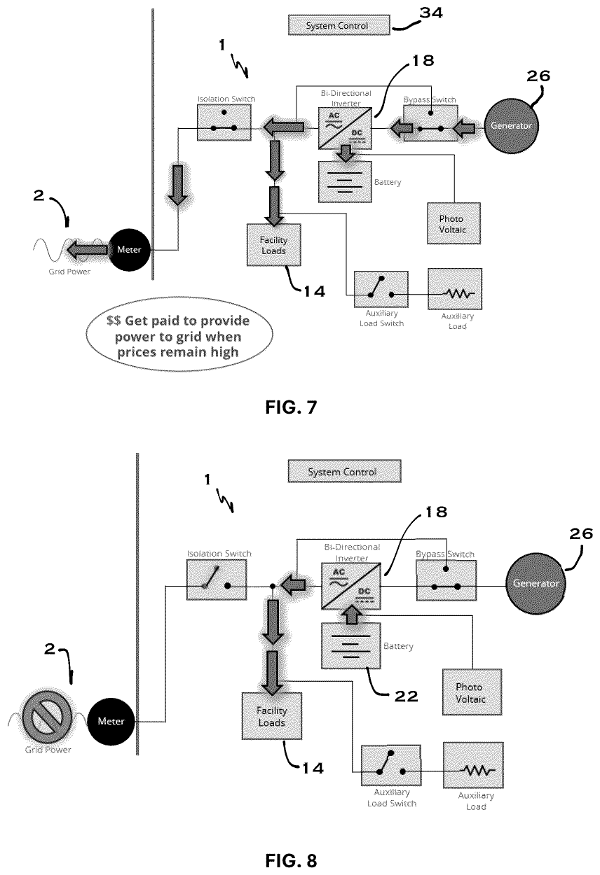

FIG. 7 depicts longer-term Hybrid Generator System support of the power grid. FIG. 7 is similar to the system in FIG. 6 in that the on-site power system 1 exports electrical power to the grid 2 in addition to supporting facility loads 14. In this instance, power to the inverter 18 is supplied by the on-site generator instead of the battery 22 (series hybrid). In some embodiments, the generator 26 is simultaneously recharges the battery 22. Although the schematic shows generator power being supplied to the grid via the inverter, the generator 26 could also be connected directly to the grid.

FIG. 8 shows a failed grid, wherein at least one battery 22 provides instant support of facility loads 14, similar to the function of an uninterruptible power supply (UPS). Note that the inverter 18 remains in operation and in communication with the grid 2 under normal circumstances, thus enabling instant or near instant takeup of facility loads upon grid failure. When a blackout occurs the battery 22, via the inverter 18, powers facility loads 14. In operation, when the system controller 34 determines that a blackout has occurred the switch 42 is opened immediately to isolate the on-site power system 1 from the now de-energized grid 2. Upon grid restoration, the system controller 34 determines if reconnection is safe, resynchronizes the inverter to the grid, and reconnects the on-site power system to the grid.

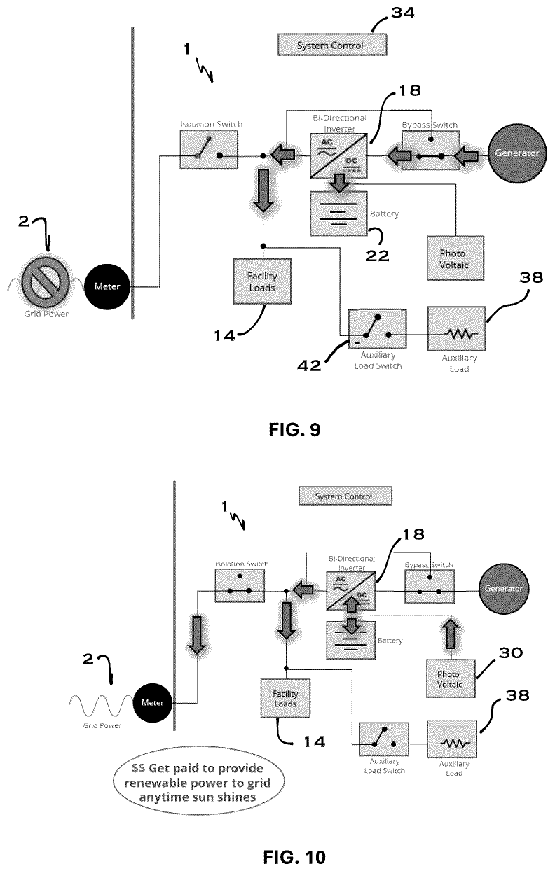

FIG. 9 shows another example of a failed grid, wherein the generator 26 provides long duration support of facility loads. This operating mode typically is triggered by the system controller 34 when the system battery 22 is near exhaustion from driving the inverter 18 during initial stages of the grid failure. The function provided in this operating mode is similar to that provided by a traditional genset—backup power for facility loads 14 during a blackout. In this mode, the generator 26 also recharges the battery 22 to an appropriate state of charge.

FIG. 10 depicts a renewable power system 30 configured to contribute power to facility loads 14 and the grid 2. Here, renewable energy, e.g., from a PV system, is fed to the facility AC bus via the inverter 18. When power available from the renewable source(s) is greater than facility loads 38, the excess is exported to the grid 2. When renewable power is less than facility loads 14, the consumption of grid power is reduced by the amount of available renewable generation.

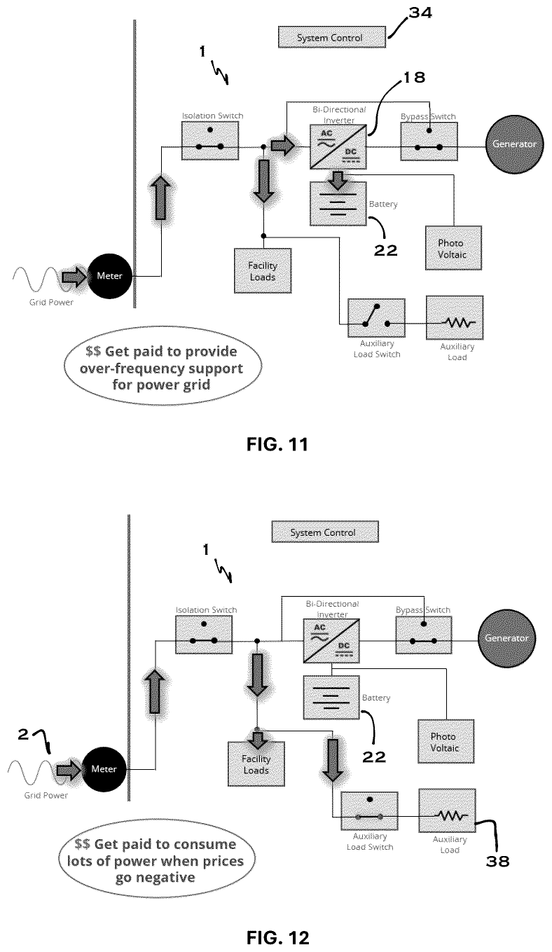

FIG. 11 depicts a Hybrid Generator System 1, which come in one embodiment, is configured to provide over-frequency support to the grid 2. This mode of operation is similar to that depicted in FIG. 6. In this example, the battery 22 serves as a short-duration energy sink that consumes energy from the grid 2, versus in the low depicted in FIG. 6, where the battery 22 is an energy source contributing energy to the grid. The inverter 18 may respond autonomously to grid over-frequency by converting grid AC into DC to charge the battery 22. This is possible because the battery's normal condition is at partial state of charge (PSOC). Alternatively, the inverter 18 may respond to the system controller 34, or from a command issued by the grid authority.

FIG. 12 depicts an on-site power system configured to provide “distributed curtailment,” which is similar to that described in FIG. 11. One of ordinary skill in the art will appreciate that sometimes renewable energy sources periodically produce excess power. When such an “over-frequency” event lasts longer than the battery 22 has capacity to absorb the excess, or when market demand (e.g., negative electric prices) justifies longer-term operation than the battery 22 has capacity to absorb, artificial load(s) are connected to the grid 2. Excess renewable generation is traditionally “curtailed” by energy producers at centralized locations. When the grid is insufficiently loaded to exploit excess generation, it must be curtailed, or grid frequency and voltage would become excessive and destructive. In addition to the specific loads depicted and described in FIG. 3 described above, other auxiliary loads 38 could be added to the system. Examples include the building management system increasing discretionary loads, such as air conditioning, computing tasks that are not time-critical, heating water, heating sidewalks, etc.

With reference to FIG. 5, one of ordinary skill in your will appreciate that the inverter 18 delivers energy in parallel with the grid to support start-up surge power to the facility load. In other words, one power source augments the other. And referring to FIG. 9, the generator (via the inverter) powers the facility load. This is equivalent to a “series hybrid” inverter generator, wherein only the single power source is available to the facility load.

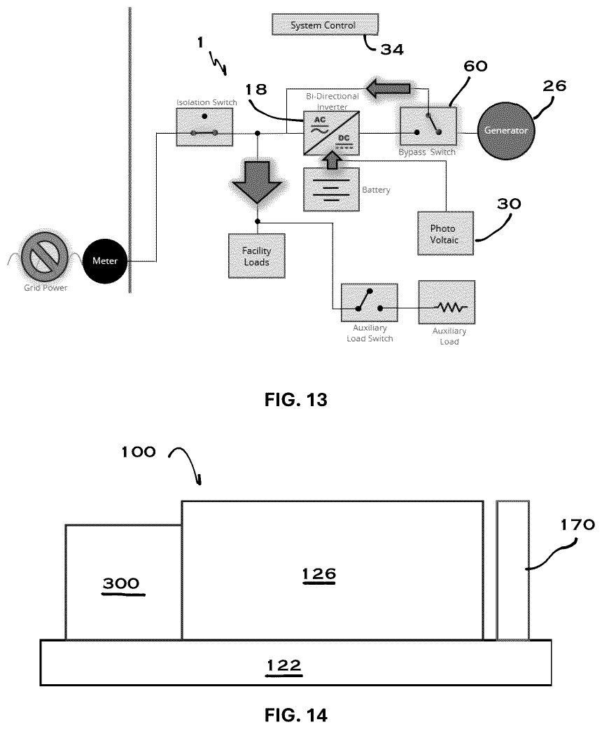

There are shortcomings with respect to the arrangement shown in FIGS. 5 and 9. When the grid is not available, the on-site power system might not have sufficient power to supply start-up surge power to the facility load. In FIG. 13 addresses the possible shortcomings of the configuration shown in FIGS. 5 and 9 by providing a direct connection from the generator's AC output (prior to any rectification needed to drive the inverter), wherein the generator's output is fed directly to the facility AC bus and facility loads. In addition, one or more switches 60 simultaneously connects the generator 26 to the facility AC bus and isolates the inverter 18 from the generator 26.

The embodiment shown in FIG. 13 offers a solution to provide startup surge power beyond the generator's capacity when the grid is unavailable, which is equivalent to a “parallel hybrid” inverter/generator in which the generator and inverter augment each other to supply surge power. This operating condition would only occur when the grid is unavailable, and only for a duration limited by the battery's capacity. As with other operating modes, the system control 34 would coordinate synchronization between inverter 18 and generator 26 before paralleling these sources. Thus, there would be no need to operate the inverter and generator in parallel when the grid is available. These changes ensure that full power from the generator flows to the AC bus, and that the inverter's only input is from the battery, or from the renewable energy source 30.

FIG. 14 a schematic view of a hybrid generator system 1 of one embodiment of the present invention comprising at least one prime mover 100, that may consist of a gaseous fueled internal combustion engine (i.e., an engine fueled by natural gas, renewable natural gas, hydrogen, etc.). Alternatives include any type of reciprocating engine such as a diesel engine (which may be associated with a fuel tank located below the engine, approximately the same size as the battery or battery bank), an Atkinson cycle reciprocating engine, a gas turbine, or an external combustion (e.g., Stirling) engine. Also included is at least one battery 200, for example, a NiZn battery, a lead-acid battery, a lithium, or sodium-based battery, etc. The at least one battery may be positioned proximate to the base of the engine and the generator, and may be accessible via a slidable rack, chassis, or other slide-out assembly (i.e., a drawer) to facilitate maintenance or replacement while the engine remains mounted atop the base. In alternative arrangements, the battery could be located elsewhere in the on-site power system adjacent to other power electronics.

An energy conversion assembly is also provided that includes at least one alternator or generator, to convert mechanical energy from the engine into electrical energy, and associated inverter assemblies. The mechanical to electrical conversion assembly of one embodiment includes an engine-driven alternator that creates alternating current (AC). The AC may be rectified to create a DC bus to which on-site renewable generation resources (not shown) may be connected to the system. Alternatively, the engine could drive a DC generator.

Embodiments of the present invention also employ at least one inverter 300 to convert cither AC or DC electrical energy from either the battery or the electrical conversion assembly's AC or DC output into regulated 50 or 60 Hz AC that is synchronized to power grid frequency.

A liquid cooling system 400 is used to cool power electronics (e.g., the inverter), engine cooling, and cooling the “distributed curtailment” load bank (only in use when the engine is not running), which will be described in further detail below. The cooling system may be similar to a conventional internal combustion engine (ICE) system, with water pump(s), radiator, water hoses, etc. The system differs from a conventional ICE cooling system, however, in that there are three different types of cooling demands imposed on the radiator and liquid pump system. In one embodiment, all three of these cooling demands would not be simultaneous:

When the inverter 300 and battery 200 are operational, before engine start, the cooling system 400 only needs to cool the system power electronics. When the engine 100 is running the cooling system must cool both power electronics and engine. When the distributed curtailment function is operational, the cooling system 400 cools an electric load bank, with only modest demand for cooling by the power electronics. The engine would not be operational during distributed curtailment and would, thus, add no heat to the engine cooling system. Either a single or two stacked radiators could be used, similar to the stacking of vehicle air conditioner radiators ahead of the ICE radiator. When a single radiator is used, a three-way cooling valve is added to the system to support a cooling loop for the curtailment, a cooling loop for power electronics when the engine is running (thermostat open), and a cooling loop for power electronics when the engine is not running (thermostat closed).

Pump(s) move coolant through the cooling system and fan(s) to move air through the radiator. The electrically driven coolant pumps and fan motors could be either fixed speed or variable speed to reduce energy consumption and noise. As with vehicle operated electric cooling fans, operation would be governed by a control system driven by sensors of power electronics, engine and load bank function and/or temperature. In some embodiments, the electrical cooling fan may be in addition to an engine driven cooling fan.

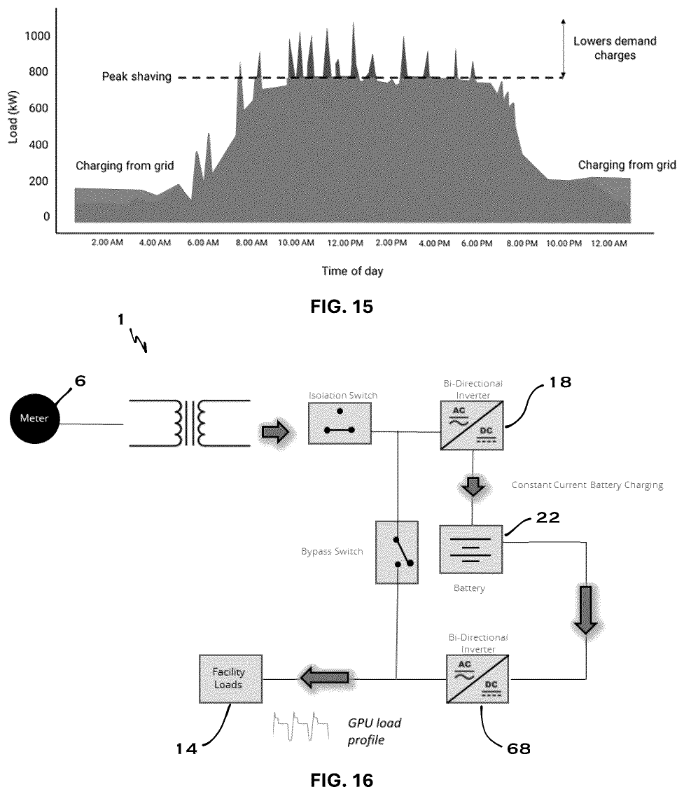

FIGS. 15-17 illustrate how the on-site power system of one embodiment of the present invention functions as a bi-directional power buffer that provides uninterruptible power supply (UPS). One of ordinary skill in the art will appreciate that UPS is an energy storage and power conditioning system that provides continuous, reliable power to electrical loads and can operate in a bi-directional mode. In normal operation, the UPS draws power from the grid or another primary source to supply the load and to charge its energy storage component, typically batteries or flywheels. When the primary source experiences an interruption, fluctuation, or failure, the UPS instantaneously supplies power from the stored energy to maintain uninterrupted operation of the load. Modern UPS systems use bi-directional power converters to both charge the energy storage device and discharge energy back to the load or, in certain configurations, to the grid.

It is thus a goal of one embodiment of the present invention to address increased dynamic load problems often occurring at datacenters where GPU loads used for AI processing cause power quality issues both inside the facility and for the utility power grid. Here, stacked on top of the power buffer (as described below) is UPS functionality, ideally located at the medium voltage entrance, to provide buffering for peak power shaving and back-up power during grid outages. Furthermore, this system can provide four quadrant grid support for power quality issues such as low or high frequency and positive and negative reactive power.

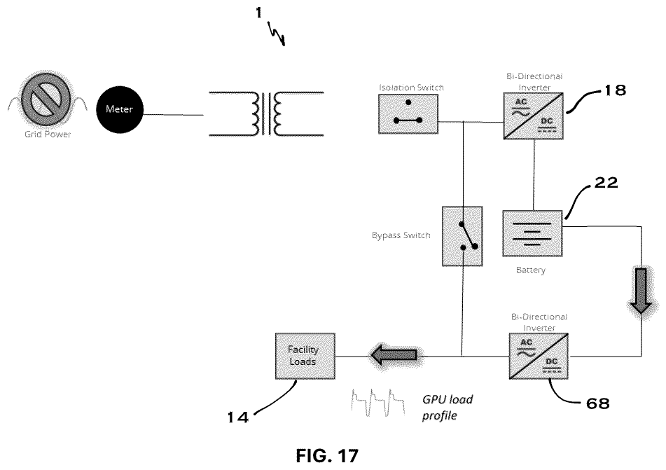

FIGS. 16 and 17 illustrate two power-conversion stages in which the battery charger associated with the battery 22 draws power from the grid 2 or from a behind-the-meter power-generating source (for example, a generator as described above). In a second power-conversion stage, a grid-forming inverter 68 with fast dynamic response supplies the rapid current peaks and valleys required by highly dynamic loads such as AI GPUs performing parallel processing. In contrast, the control system of the first power conversion stage responds more slowly so that peaks and valleys in the current drawn by the second-stage converter 68 are not propagated back into the grid or the main power-generating source. The battery 22 supplies the high-peak currents required by the second inverter stage 68 and provides a power buffer to reduce peak power draw as measured at the meter 6 as well as to supply energy during a grid outage. The battery 22 is maintained below full charge so that the battery charger (i.e., the bidirectional inverter 18) can continue to deliver current to the battery 22 even during short periods of low demand from the load.

One advantage of the contemplated system is that its buffering capability also functions as an uninterruptible power supply (UPS), eliminating the need for separate UPS units within the data center and, thereby, freeing valuable floor space. Moreover, because the system performs both UPS and buffering functions, it eliminates the need for additional buffering equipment located closer to the GPUs (for example, within server racks). This centralized, dual-function design is more energy-efficient than alternative solutions that require additional power-conversion steps. Energy efficiency is a key priority for data-center operators and engineers. Further, the system is positioned at the medium-voltage entrance to the data center. Centralized systems at this level are easier to manage and less costly than deploying large numbers of small buffering devices distributed throughout the data center.

One of skill in the art will appreciate that the battery charging aspects described in the patents referred to above can be incorporated into the systems disclosed herein. For example, the systems disclosed herein may be associated with a battery-life-extension charging system, comprising: a monitoring component configured to measure a direct current (DC) output current delivered by the charging system to a battery, wherein the DC output current is a function of an existing charge status of the battery; a timing component; and a charge control system in communication with the monitoring component and the timing component, the charge control system configured for: obtaining at least one of a time measurement from the timing component and a charge measurement from the monitoring component; based on the at least one of the time measurement and the charge measurement, determining at least one of a time to complete the charge mode cycle and a charge to complete a charge mode cycle, each tailored to achieve a desired charge status of the battery; and based on at least one of the determined time and the determined charge to complete the charge mode cycle, transitioning to a select one of a number of DC output voltage settings until the determined time to complete the determined charge mode cycle has passed or the charge to complete the charge mode cycle has been provided, wherein the DC output voltage settings include at least an eco-float output voltage setting, a refresh output voltage setting, and a boost output voltage setting.

In operation, the charging system obtains a charge measurement associated with a battery via a monitoring component of a battery charger, the charge measurement reflecting a direct current (DC) output current delivered by the battery charger to the battery; obtains a time measurement associated with the battery via a timing component of the battery charger; transmits at least one of the charge measurement and the time measurement to a battery charge control system of the battery charger; determines, by the battery charge control system and based on at least one of the charge measurement and the time measurement, at least one of a charge to complete a charge mode cycle and a time to complete the charge mode cycle, the charge mode cycle is tailored to achieve a desired charge status of the battery; and selectively regulates, by a voltage regulator in communication with the battery charge control system, a DC output voltage of the battery charger to one of a number of pre-set DC output voltages until the time to complete the charge mode cycle has passed or the charge to complete the charge mode cycle has been provided, the pre-set DC output voltages comprising an eco-float output voltage, a refresh output voltage, and a boost output voltage.

In another embodiment, the battery charging system is configured to selectively transfer current from a charger to at least one interconnected battery and comprises at least a monitoring component configured to measure: an existing charge status of the at least one interconnected battery, a direct current (DC) output current delivered by the charger to at least one interconnected battery, wherein the DC output current is a function of the existing charge status of the at least one interconnected battery, and a temperature of the at least one interconnected battery; a control system in communication with the monitoring component and a timing component, the control system configured to initiate charging of the at least one interconnected battery based on a first temperature of the at least one interconnected battery, wherein the control system obtains a time measurement from the timing component and/or a charge measurement from the monitoring component; wherein based on the time measurement and/or the charge measurement, defining at least one of a time to complete a charge mode cycle and a charge required to complete a charge mode cycle that are tailored to achieve a desired charge status of the at least one interconnected battery; based on at least one of a determined time and a determined charge to complete the charge mode cycle, transitioning to a select one of a number of DC output voltage settings until the determined time to complete a determined charge mode cycle has passed or the charge to complete the charge mode cycle has been provided, wherein the DC output voltage settings include a boost output voltage setting, a float output voltage setting, and an eco-float output voltage setting; wherein the eco-float output voltage setting is associated with a voltage less than the float output voltage setting and nominally higher than an open-circuit voltage of the at least one interconnected battery, with a near zero charge current provided to the at least one interconnected battery to maintain the at least one interconnected battery at a partial charge state, while allowing the at least one interconnected battery to support an external load; wherein the float output voltage setting comprises a transition from the boost output voltage setting to the eco-float output voltage setting in a series of incremental voltage changes; and wherein the charger will cease delivering current to the at least one interconnected battery if the at least one interconnected battery reaches a second temperature that is greater than the first temperature.

In this example, the charging system obtains a charge measurement associated with a battery via a monitoring component of a battery charger, the charge measurement reflecting a direct current DC output current delivered by the battery charger to the battery; obtains a time measurement associated with the battery via a timing component of the battery charger; obtains a battery temperature measurement; transmits at least one of the charge measurement, the time measurement, and the battery temperature measurement to a battery charge control system of the battery charger; initiates battery charge, wherein the battery charge control system directs the battery charger to direct current to the battery; determines, by the battery charge control system and based on at least one of the charge measurement, the time measurement, and the battery temperature measurement, a charge to complete a charge mode cycle and/or a time to complete the charge mode cycle, the charge mode cycle being tailored to achieve a desired charge status of the battery; selectively regulates, by a voltage regulator in communication with the battery charge control system, a DC output voltage of the battery charger to one of a number of pre-set DC output voltages until the time to complete the charge mode cycle has passed or the charge to complete the charge mode cycle has been provided, the pre-set DC output voltages comprising a boost output voltage setting, a float voltage output setting, and an eco-float output voltage setting; wherein the eco-float output voltage setting is associated with a voltage less than the float voltage output setting and nominally higher than an open-circuit voltage of the battery, with a near zero charge current provided to the battery to maintain the battery at a partial charge state, while allowing the battery to support an external load; and wherein the float output voltage setting comprises a transition from the boost output voltage setting to the eco-float output voltage setting in a series of incremental voltage changes; and ceases battery charging if the battery temperature measurement indicates a battery temperature above a predetermined maximum temperature.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being conducted in numerous ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

It should be noted that all features, elements, components, functions, and steps described with respect to any embodiment provided herein are intended to be freely combinable and substitutable with those from any other embodiment, or with the concepts disclosed in the patents or applications incorporated by reference herein. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that it would be possible to provide for some features of the embodiments of the present invention without providing others. Stated differently, any one or more aspects, features, elements, means, or embodiments as disclosed herein may be combined with any one or more other aspects, features, elements, means, or embodiments as disclosed herein.

What is claimed is:

1. A hybrid generator system associated with an alternating-current power grid and a facility load; comprising:
an inverter associated with the power grid and to a battery;
a generator electrically associated with the inverter;
a renewable power source electrically associated with the inverter;
an isolation switch configured to disconnect a facility from the power grid during a power outage;
an isolation load associated with the isolation switch and the power grid;
a system controller in communication with the inverter, the generator, the battery, the isolation switch, the auxiliary load, and the renewable power source;
wherein, during a grid under-frequency event, the system controller commands the inverter to export power to the grid from the battery; and
wherein, during a grid over-frequency condition or a negative-price interval, the system controller commands the inverter to draw power from the grid to charge the battery, and when battery capacity to draw power is exceeded or a curtailment threshold is met, the system controller commands the inverter to connect the auxiliary load to consume surplus power.

2. The system of claim 1, wherein the system controller starts the generator before the battery reaches a depletion threshold and commands the inverter to export power from the generator to the grid while maintaining the facility load.

3. The system of claim 1, wherein the battery is operated at partial state of charge to provide bidirectional primary frequency response.

4. The system of claim 1, wherein the system controller is configured to respond to commands or telemetry with a grid authority or virtual power plant platform.

5. The system of claim 1, wherein the renewable power source comprises a photovoltaic array, a wind turbine, or an AC power source connected to the inverter.

6. The system of claim 1, wherein the inverter regulates real and reactive power independently according to a decrease or setpoint received from the system controller.

7. The system of claim 1, wherein the auxiliary load is configured as a resistive heating element thermally coupled to a liquid cooling loop.

8. The system of claim 1, wherein the system controller operates a surge-support mode wherein the inverter augments grid power to provide short duration surge power.

9. The system of claim 1, further comprising at least one resistive element embedded in or thermally coupled to a liquid cooling circuit that is configured to cool the inverter, the liquid cooling circuit having a three-way valve that selectively routes coolant among a generator loop, a power-electronics loop, and a load-bank loop; and
wherein radiator fans and coolant pumps are electrically driven and speed-controlled according to temperatures of the generator, the inverter, and the load bank.

10. A method of operating a hybrid generator system including an inverter connected to a facility alternating-current (AC) bus, a battery connected to a direct-current (DC) port of the inverter, a generator selectively connectable to the AC bus, an on-site renewable power source connected to the inverter, a controllable load bank, an isolation switch between the AC bus and a power grid, and a controller in communication with each component, the method comprising:
in a first mode of use, during normal grid operation, maintaining the battery at a partial state of charge while the inverter operates in synchronism with the power grid to supply facility loads and to augment grid power during transient load surges without starting the generator;
in a second mode of use, during a grid under-frequency event, exporting power from at least the battery through the inverter to the grid and, when the event persists beyond the battery's capacity, starting the generator and continuing export of power to the grid while supplying facility loads;
in a third mode of use, during a grid outage, opening the isolation switch to isolate a facility and initially supplying facility loads from the battery through the inverter, then starting the generator to provide longer-duration support and optionally to recharge the battery;
in a fourth mode of use, during a grid over-frequency condition or other excess-generation event, importing power from the grid to charge the battery through the inverter and, when battery capacity to absorb power is exceeded, connecting the controllable load bank to the inverter to consume surplus power;
in a fifth mode of use, during a grid outage that requires surge power beyond generator capacity, synchronizing the inverter with the generator and connecting the generator directly to the facility AC bus while the inverter draws power from the battery in parallel with the generator for a duration limited by the battery's capacity; and
controlling transitions among the modes according to sensed grid and facility conditions and commands received from a grid authority.

11. A method of operating a hybrid generator system; comprising;
synchronizing an inverter with a power grid;
maintaining a battery associated with the inverter at partial state of charge;
detecting a grid under-frequency event;
exporting power to the grid from the battery via the inverter;
starting an engine-driven generator and continuing power export to the grid; and
upon a grid outage, opening an isolation switch and supplying facility loads from the battery via the inverter until a generator assumes a longer-duration operation.

12. The method of claim 11, further comprising commanding the inverter to provide reactive power per a setpoint while exporting real power.

13. The method of claim 11, further comprising receiving a dispatch signal from a grid authority or virtual power plant and adjusting export setpoints accordingly.

14. The method of claim 11, wherein the inverter supplements grid power to support a facility surge load during normal grid operation.

15. The method of claim 11, wherein the generator simultaneously powers the inverter and recharges the battery.

16. The method of claim 11, further comprising transitioning to independent operation and resynchronizing to the grid upon restoration.

17. The method of claim 11, wherein power export continues until a price cap or duration limit is met.

18. The method of claim 11, wherein a renewable power source supplies the inverter during normal operation power export or independent operation.
